(19) United States
(12) Patent Application Publication
(10) Pub. No.: US 2006/0092674 A1
(43) Pub. Date: May 4, 2006

(54) Powered hand held devices

(76) Inventors: Jason A. Belton, Doylestown, OH (US); James A. Kovach, Parma, OH (US); Charles J. Mintz, Highland Heights, OH (US); Kirk C. Palmerton, Kent, OH (US); Rick W. Walker, Stow, OH (US)

Correspondence Address: JEANNE E. LONGMUIR, 2836 CORYDON ROAD, CLEVELAND HEIGHTS, OH, 44118, US

(21) Appl. No.: 11/263,807

(22) Filed: Nov. 1, 2005

Related U.S. Application Data
(60) Provisional application No. 60/624,044, filed on Nov. 1, 2004.

(51) Int. Cl. H02M 3/34

(52) U.S. Cl. 363/32

(57) ABSTRACT

A powered hand held device having an improved power supply with both a low power source in parallel with a high power source from ultracapacitors. The ultracapacitor power is used by the device motor during certain peak power demands which require high power to the device motor. An improved hand held tube cutter tool is provided both with and without the improved power arrangement, and includes a rotating cutter head assembly with an adjustable roller assembly providing a superior tube cut.

### CROSS REFERENCE TO RELATED APPLICATIONS

The present application claims priority from U.S. Patent Application Ser. No. 60/624,044 filed Nov. 1, 2004, the entire subject matter of which is incorporated herein by reference.

### BACKGROUND OF THE INVENTION

1. Field of Invention

The present invention is directed to hand held devices having specific power requirements, more specifically, powered hand held devices having motors supplying physical actuation during operation; such as hand tools, for use as plumbing tools such as tube cutters or drain cleaners, or medical devices; household tools, for example, can openers or toothbrushes; or hand held toys or games, such as bubble makers.

2. Background of the Related Art

In the past, the development of hand held and/or portable consumer products required operating motors with both high power requirements during shorter term peaks of operation (for example, at the start or finish of a cycle), and longer, lower energy requirements, such as continuous rotation by the motor during mid-cycle operation. Batteries alone were often unable to satisfy such variable energy requirements, and such proposed consumer devices were abandoned due to inadequate power supplies.

Examples of power consumptive hand tools include those illustrated in U.S. Pat. Nos. 5,315,759, 5,943,778, 6,095,021 and 6,637,115. Each provides an externally powered tube cutting tool which is adjustable to cut tubes of various diameters, and which automatically turns the tube to be cut. The power requirements of such devices are initially high for a short time as the tube is first cut, but are lower for a longer time as the remainder of the tube is rotated and cut.

### BRIEF SUMMARY OF THE INVENTION

The present invention provides a powered hand held device having an improved power supply arrangement. The device preferably includes a power supply arrangement having both a high power source component and a low power source component. The high power source is preferably supplied by ultracapacitors. The power supply arrangement provides the lower power source as a battery source in parallel with the ultracapacitors for a supplementary power arrangement. Such an arrangement enables the use of the ultracapacitors by the device motor during certain peak power demands, which are somewhat infrequent, but require high power to the motor. The ultracapacitors provide supplemental power to the motor as needed during the cycle. Such supplementation reduces the load on the low power battery source, which is then able to run longer during low power continuous operation of the hand held device, and to extend battery life in situations where device operation is very intermittent.

The battery source may be any type of conventional batteries, including rechargeable or disposable batteries, such as alkaline, nickel cadmium, nickel metal hydride, lithium ion or other commonly available power sources. The ultracapacitors, or electrical storage units of small size, are available for example from Maxwell Technologies, San Diego, Calif., and are the subject of numerous U.S. Pat. Nos. 5,621,607; 5,777,428; 5,862,035; 5,907,035; 5,907,472; 6,233,135 and 6,449,139. Alternatively, ultracapacitors may be used alone, or an AC power source may be used.

Numerous powered hand held devices may potentially benefit from such a power supply arrangement, including household tools such as a coffee grinder or can opener, which have an initial peak power requirement which is used to initiate a longer, low power continuous cycle by a motor, such as a permanent magnet motor, which generally provides rotating operation during use of the device. Similarly, hand held toys or games which may use power, such as a bubble maker, or medical devices such as a hand held endoscopic device, use a motor with variable power requirements and may benefit from the present invention. Finally, powered hand held tools, such as plumbing tools for pipe or tube cutting or drain cleaning as well as hand held medical devices, also have improved power performance using the present invention.

An improved powered hand held tube cutter device of the present invention provides rapid tube cutting with less force applied to the tube being cut. The use of more revolutions, at less force, and optionally with a sharper cutting wheel, results in less burr to the tube being cut. The length of time the cutting wheel remains sharp is optionally improved using a cryogenic treatment. The cutter wheel assembly of the present device includes an adjustable rocking roller assembly, which may be moved to accommodate two different diameters of tubes to be cut. Additionally, the cutting wheel is housed within a cutter wheel housing which provides the cutting wheel in spring biased engagement with the tube to be cut. Engagement of the cutting wheel using an improved roller assembly for engaging the tube to be cut reduces displacement of the spring biased cutting wheel, resulting in a reduction of the spring force applied to the tube to be cut. Thus, the roller assembly retains the tube on one side, with the spring biased cutting wheel engaged with the tube on a side opposite the roller assembly. The present tool may be used with either the improved power supply arrangement previously described, or with a conventional power supply, such as rechargeable or disposable batteries, which are positioned within the tool handle assembly, or an AC power supply.

The improved device provides continuous 360° of rotation of the cutter wheel assembly relative to the tube being cut. Specifically, a door is provided which may be opened and closed once the tube is positioned within the tool cutter wheel assembly housing, and allows full rotation about an existing in-line piece of pipe or on a closed loop piping system. The door is moved to a “closed” position by the geometry of the cutter wheel housing once the tube is engaged within the tool, and is maintained in a “closed” position by a magnetic latch and the tool housing. Additionally, when the cutting operation is complete, the tool speed is reduced and tool operation is eventually stopped at a home position. The door is moved to an “open” position as the tool and tube are disengaged.

An on/off switch is provided on the device. In the on position, power is supplied to an LED assembly, and initiates charging of any ultracapacitors. A secondary trigger switch for operating the device is also provided. Once the tube to be cut is engaged with the tool device, activation of the trigger switch initiates movement of the cutter wheel assembly to close the door and start the cutting action.

The use of an LED assembly, optionally including one or more LED's which may illuminate an optional light pipe, enable direct illumination of the work piece, and show the tool cutting line by providing a shadow from the cutting wheel onto the tube at the location to be cut. An alternative laser line projector may also be provided on the top of the tool to provide a cut line of the work piece being cut.

As shown in the attached figures, an angled handle is provided so that the tool device may readily used for cutting of in-line tubing in difficult to reach locations.

### BRIEF DESCRIPTION OF THE DRAWINGS

FIG. 1 illustrates a schematic exploded partial perspective view of components of a powered hand held device according to the present application;

FIG. 2 illustrates a schematic partial, cut-away bottom view of components of a powered hand held device according to the present application;

FIG. 3 illustrates a schematic exploded partial perspective view of cutting wheel assembly of the device illustrated in FIG. 1;

FIG. 4 illustrates a schematic partial bottom view of components of the drive train of the powered hand held device illustrated in FIG. 2;

FIGS. 5 and 6 illustrate schematic partial bottom views of the cutter wheel assembly of the improved hand held device of this application, with the roller assembly shown in alternate positions to accommodate different sizes of tubing to be cut;

FIGS. 7 and 8 illustrate schematic partial perspective top and bottom views, respectively, of components of the cutter wheel assembly engaged, for demonstration, with two different sizes of tubing to be cut;

FIG. 9a illustrates a schematic partial bottom view of components of a cutter wheel assembly without the rocking roller assembly of the present application, for comparison with FIG. 9b which illustrates a schematic partial bottom view of components of a cutter wheel assembly with a rocking roller assembly as in the present application;

FIG. 10 illustrates a simple schematic circuit diagram for an improved power arrangement for a powered hand held device according to the present application;

FIG. 11 illustrates a more detailed schematic circuit diagram for an improved power arrangement for a powered hand held device according to the present application;

FIG. 12 illustrates a single 2.5 Volt, 10 F ultracapacitor of which several are shown in use in the schematic circuit diagram of FIGS. 10 and 11, and for which additional or different capacities may of course be used depending on the power requirements of the specific hand held device application; and

FIG. 13 shows a schematic perspective illustration of a charger dock for a battery source used in connection with an embodiment of the hand held device of the present application.

### DETAILED DESCRIPTION OF THE INVENTION

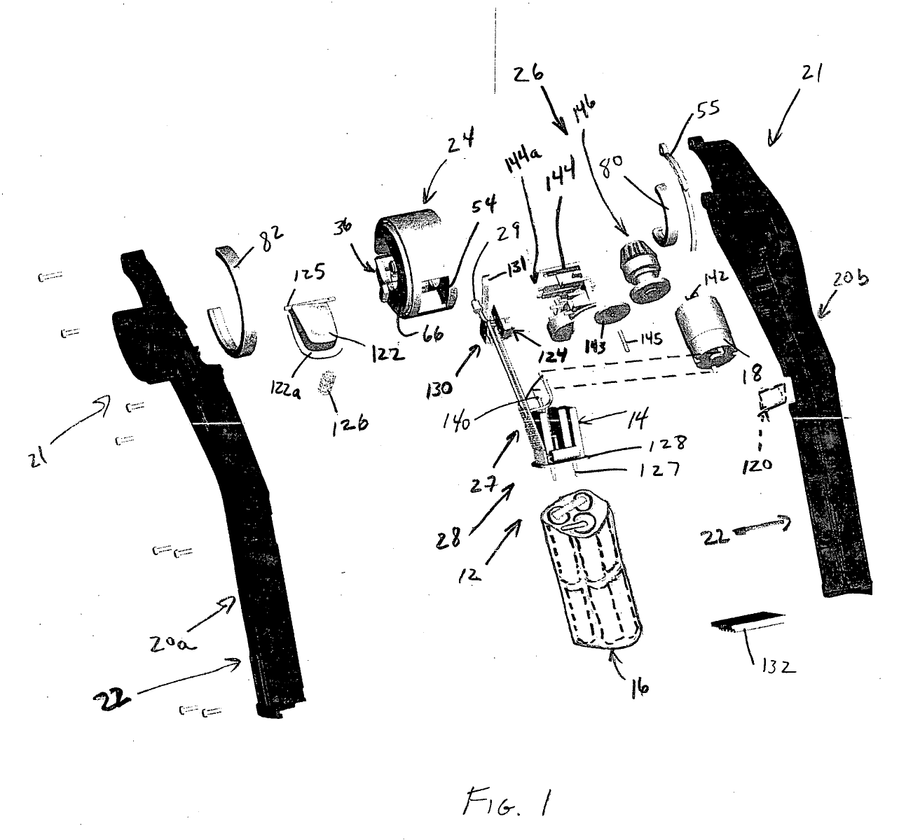

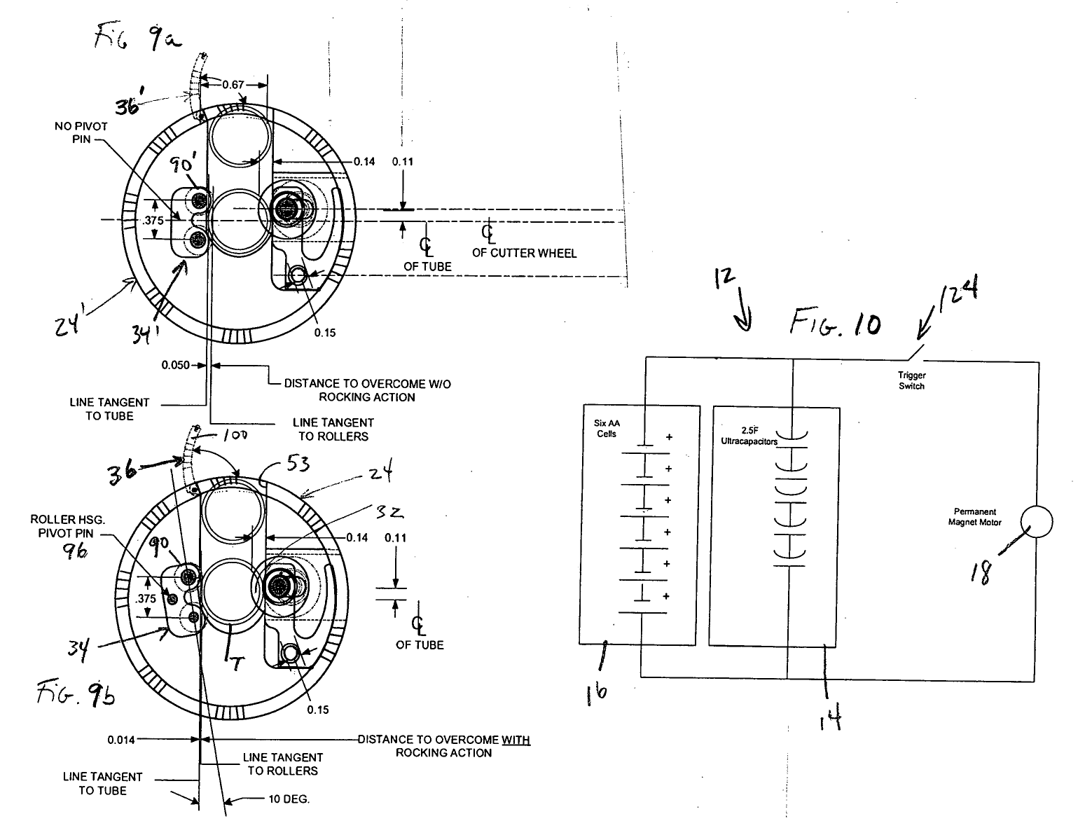

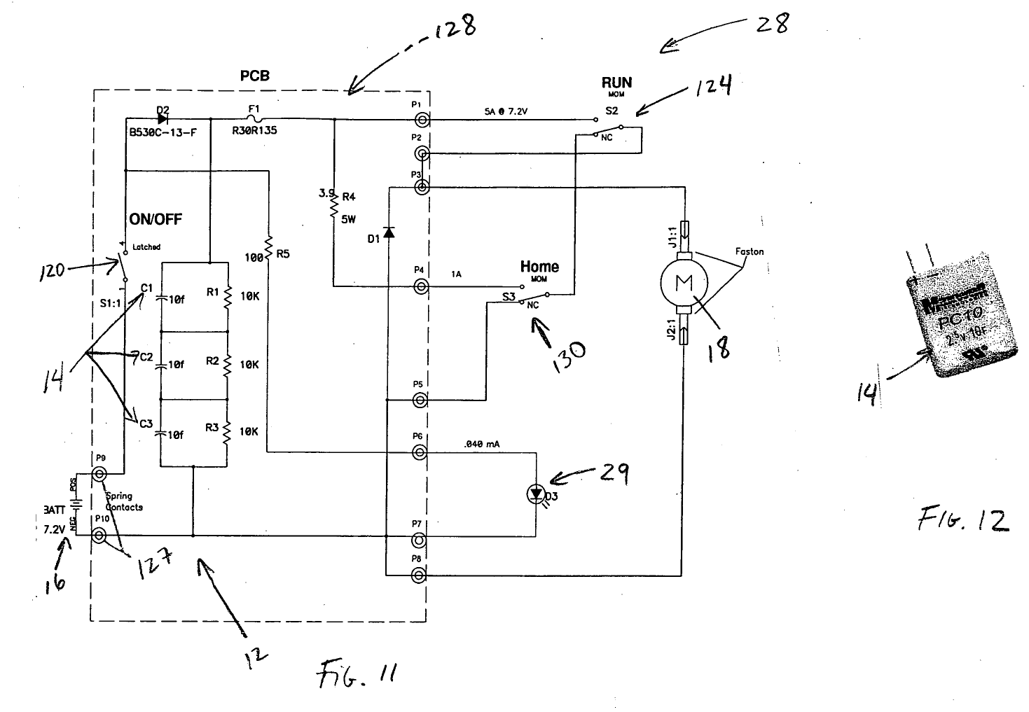

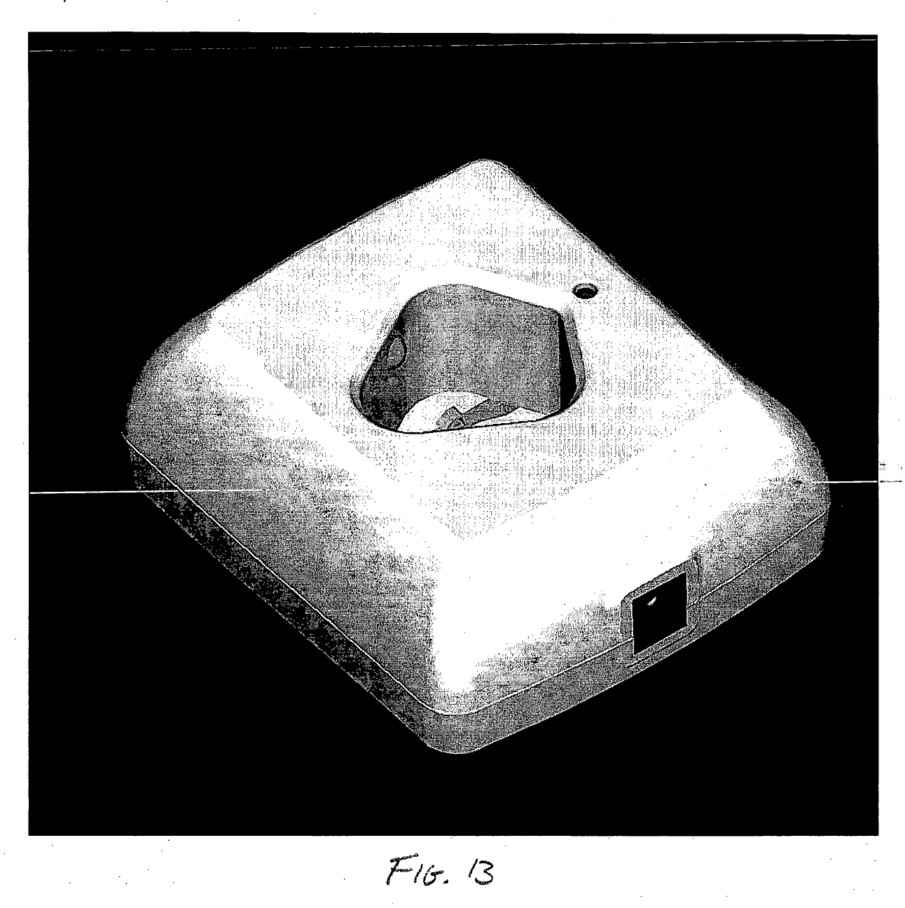

FIG. 1 discloses a powered hand held device 10 having an improved power supply arrangement 12 and an improved design for a tube or pipe cutter for use in plumbing or other applications. The power supply arrangement preferably has both a high power source component and a low power source component. In the embodiment of FIG. 1, the device is a powered hand held tube cutting device. The high power source is preferably supplied by ultracapacitors 14. The power supply arrangement provides the low power source, disclosed as a battery 16, in parallel with the ultracapacitors 14 for a supplementary power arrangement, as shown in FIG. 10. Such an arrangement enables the use of the ultracapacitors 14 by a motor 18 of the device 10 during certain peak power demands. The motor to be supplied with power may be a 110 Volt AC motor of the type manufactured by GE or Westinghouse corporations, but in the preferred embodiment is a 3.6 Volt permanent magnet DC motor available from Johnson Motors Inc. Three ultracapacitors 14 are used in the illustrated embodiment of FIGS. 10 and 12 as 2.5V 10 Farad, PC 10 ultracapacitors by Maxwell Technologies, Inc. Where peak power usage is infrequent in a hand held device, but high power is still required to be delivered to the motor 18, the ultracapacitors 14 provide supplemental power to the motor 18 as needed during device operation. Such supplementation reduces the load on the low power source, which is then able to run longer during low power continuous operation of the hand held device. Where the low power source is a battery, battery life is extended.

The low power source may be any type of conventional power source, including rechargeable or disposable batteries, such as alkaline, nickel cadmium, nickel metal hydride, lithium ion or other commonly available power sources, and/or an AC power source may be used. In the embodiment of FIGS. 1, 10 and 11, 6 AA nickel metal hydride batteries are used which may be recharged in a conventional docking station of the type shown in FIG. 13.

The improved powered hand held tube cutter device 10 of the present application is illustrated in FIG. 1. The device 10 performs the tube cutting operation with a superior result, by the application of higher revolutions of the cutter wheel to the tube being cut. The use of higher revolutions enables the application of less force on the tube by the tool cutting wheel which in turn enables the use of a sharper tool cutting wheel, since the application of lower force on the tube decreases risk of damage to the cutting wheel during operation.

As shown in FIG. 1, the powered hand held device 10 is a tube or pipe cutter. The device 10 includes a tool housing 20, having an operating end 21 and a handle portion 22, and supporting a power supply 12, including a battery 16 and ultracapacitors 14 within the handle portion 22; a rotating cutter head assembly 24; a drive assembly 26; and a control system 28. In the improved device, the cutter head assembly 24 is positioned at the operating end 21 of the device 10, surrounds a tube T to be cut, and provides 360° of rotation relative to the tube being cut.

As shown in more detail and various positions in FIGS. 3 and 5-8, the rotating cutter head assembly 24 surrounds a tube to be cut T, and includes a cutter head assembly housing 25 which supports a spring biased cutter wheel assembly 30 having a cutter wheel 32 for engagement with the tube T, a roller assembly 34 also for engagement with the tube T, and a door assembly 36 for surrounding the tube T during operation of the device 10 when the door assembly 36 is in a closed position. The use of a captive cutter wheel assembly 30 and roller assembly 34 are used in the improved tool to insure parallelism of the cut and to eliminate cut wander during operation.

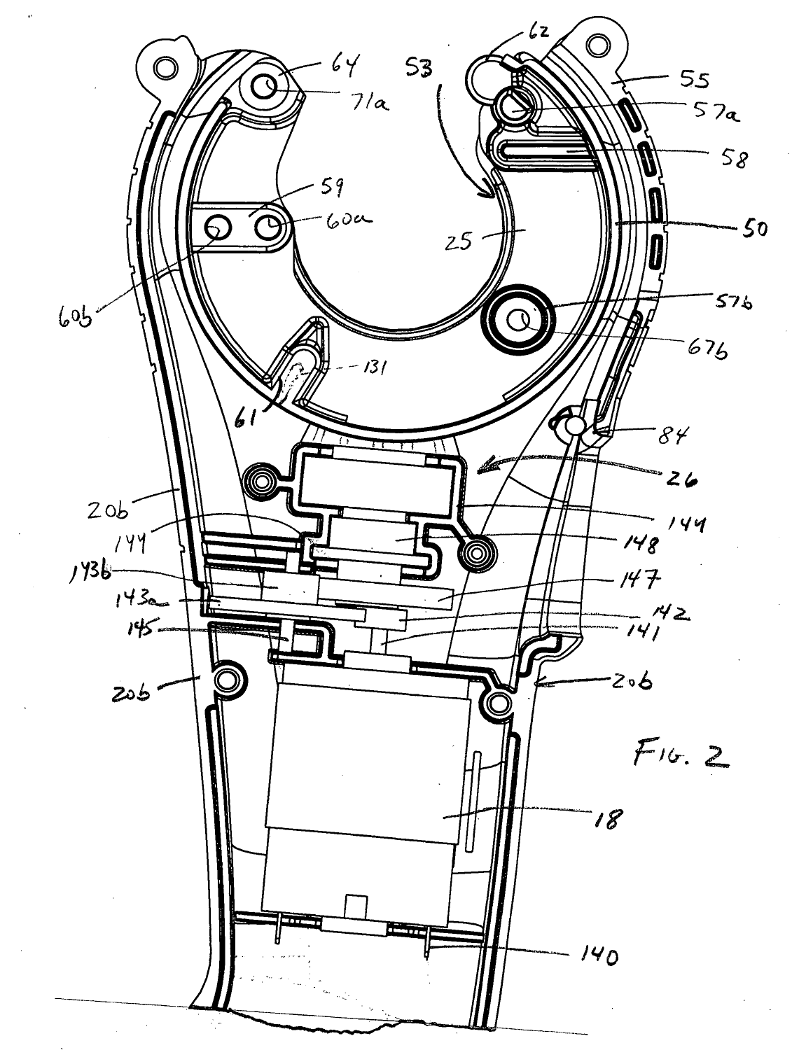

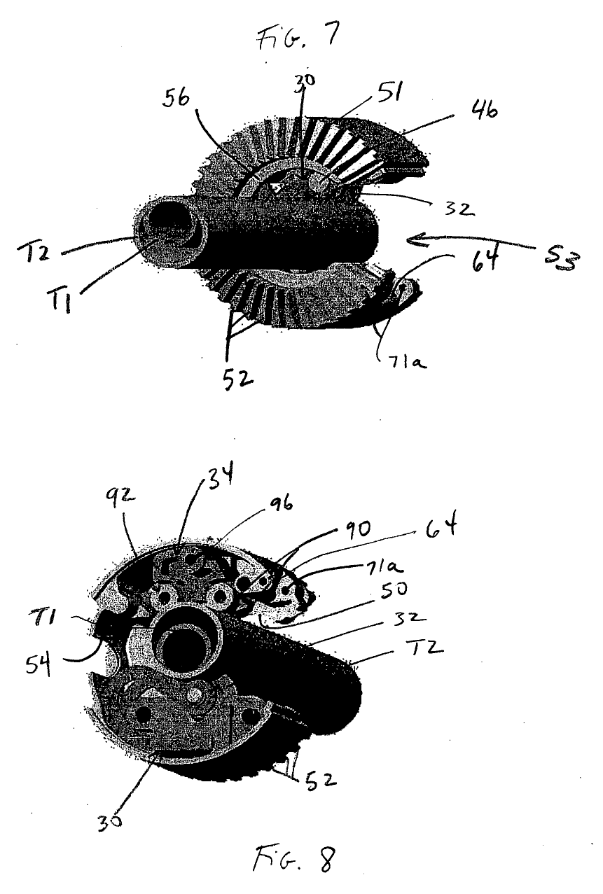

The cutter head assembly housing 25 has a substantially cylindrical configuration and is located within the operating end 21 of the tool housing 20. A cylindrical wall 50 extends away from a gear face 51 of the housing 25, which includes gear teeth 52, as shown in FIGS. 7 and 8. The gear teeth 52 are in mating engagement with the drive assembly 146, as in FIGS. 1 and 2, to provide rotation of the cutter head assembly 24. An opening 53, as shown in FIGS. 2 and 7, is provided within the wall 50 to accommodate insertion of the tube T to be cut. The opening 53 is closed by the door assembly 36 during operation of the device, to provide a continuous surface of gear teeth for engagement with the drive assembly 26. A light opening 54 is also provided opposite opening 53, to permit light supplied by an LED 29. In the current embodiment, the LED 29 displays the tool cut path by casting a shadow from the cutter wheel 32 into the tube T. It should be understood that more than one LED may be provided to enable further or direct illumination of the work piece or cut line. Alternatively, a line projecting laser light may also be mounted on the top of the device for direct illumination of the work piece or tube to be cut T. In the illustrated embodiment of FIGS. 1 and 2, a light pipe 55 is shown mounted in a seat 84 captured between halves of the tool housing 20a, 20b when the tool is assembled, such that a portion of the light pipe is outside the tool housing 20 and a portion is inside the tool housing. In this position, the light pipe 55, of a translucent polymer material, supplies light from the LED 29 externally of the device 10 to indicate that the tool is powered on and to give an external visual indication of the cutting position in addition to that of the shadow cast by the cutting wheel. Additionally, as shown in FIG. 1, a conventional fastener is engaged through a boss in the light pipe and an opening in the tool housing to secure the light pipe 55 in position between the halves of the tool housing 20a, 20b. In FIG. 1, several conventional fasteners are shown in position to be secured through aligned openings in the tool housing 20, comprised of two halves, 20a, 20b, in order to secure the device 10 in assembled condition.

The interior of the cutter head assembly housing 25, which is closed by a cover plate 66, provides various support structures for components of the cutter head assembly 24. Such support structures are molded into the housing 25 which is preferably manufactured of any conventional polymer materials suitable for such purpose to ensure smooth and quiet device operation. As shown in FIG. 7, a small bearing surface 56 on the cutter head assembly housing 25 is provided for rotating engagement with a small bearing 80 engaged within the tool housing 20 which supports rotation of the cutter head assembly 24 within the tool housing 20. In the embodiment shown in FIG. 1, the small bearing 80, and a large bearing 82 are engaged within the tool housing 20a and the cutter head assembly 24 on a side of the assembly opposite from the small bearing 80 for supporting rotation of the cutter head assembly 24 within the tool housing 20. The bearings 80, 82 are manufactured of a conventional powdered metal material for smooth rotation and quiet operation when engaged with the polymer cutter wheel housing assembly 25 and cover plate 66, but it should be understood that any of these bearing tool components may be manufactured of any appropriate polymer or metal materials.

Additional support structure within the cutter wheel assembly housing 25, shown in FIGS. 2, 3, 5 and 6, include: support posts 57a, 57b supporting the cutter wheel assembly 30; an alignment slot 58 for mating alignment with the cutter wheel assembly 30 as shown in FIG. 3; a roller assembly adjustment boss 59 for supporting the roller assembly 34 in either a first opening 60a, for supporting a first tube diameter within the roller assembly, or a second opening 60b, for supporting a second larger tube diameter within the roller assembly; a groove 61 for supporting a moving limit switch sensor arm 131 of a limit switch 130 for sensing position of the groove 61 on the cutter head assembly 24 following completion of a cut; a magnet support 62 for securing a magnet 63 therein by either press fit or adhesive engagement; a support slot 64 for supporting engagement with the door assembly 36; openings 67a, 67b for respective engagement with a cutter wheel housing fastener 68, securing the cover plate 66 and cutter wheel assembly 30 within the housing 25, and a door assembly fastener 69 for securing the door assembly in pivoting engagement with the housing 25; and a boss 59 for capture of a roller assembly axle within the housing 25.

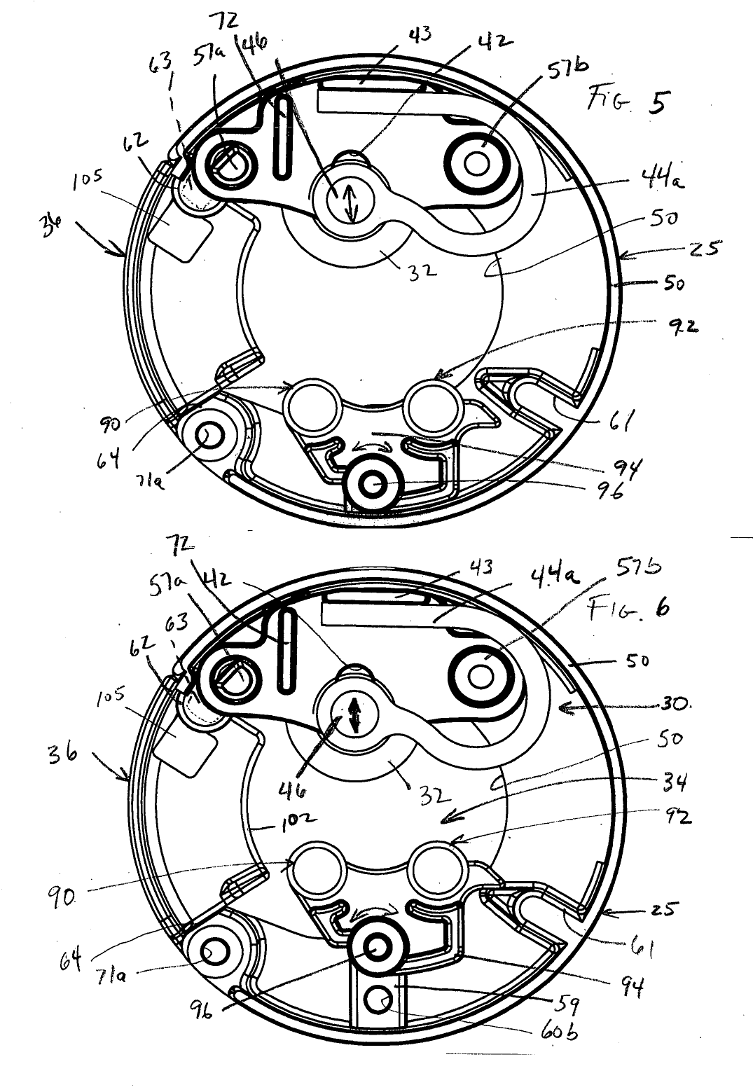

As shown in FIGS. 5 and 6, the spring biased cutter wheel assembly 30 is aligned within the cutter head assembly housing 25 by an alignment register tab 72 aligned with the alignment slot 58. The cutter wheel assembly 30 includes a cutter wheel housing 38 which is secured in aligned position on support posts 57a, 57b within the cutter head assembly housing 25 through alignment openings 40a, 40b, respectively. Sliding movement of the cutter wheel 32 is provided within the cutter wheel housing 38 upon engagement with a tube to be cut T. The cutter wheel 32 is supported on an axle 46 which is engaged within an elongate slot 42 formed within the cutter wheel housing 38. The cutter wheel 32 has a generally large diameter, between 0.7 to 0.8 inches, and a large width, 0.2 to 0.3 inches, providing stability and extending the operating life of cutter wheel 32. To further extend cutter wheel 32 life, a cryogenic treatment is used during which the cutting wheel 32 is frozen during a −300 degrees F. cryogenic metal treatment process using liquid nitrogen for metallagraphic molecular alignment.

Also engaged on the cutter wheel axle 46 are two leaf springs 44a, 44b, one of which is secured on each side of the cutter wheel housing 38. The end of each leaf spring 44a, 44b is engaged with a spring stop 43 formed in the cutter wheel housing 38.

The cutter head assembly 24 also provides an adjustable roller assembly 34 for engagement with the tube T to be cut on a side opposite from the cutter wheel assembly 30. In the preferred and illustrated embodiment, the roller assembly is adjustable to accommodate two different diameters of tubes to be cut, shown for example in FIGS. 7 and 8, where T1 is ½ inch or 15 mm tube and T2 is ¾ inch or 22 mm tube, but with only one size tube being cut at a time. It should be understood that adjustment of the present embodiment in fact accommodates four different tube diameters, but that devices 10 having alternate size designs may be created for additional smaller or larger tube sizes, with appropriate corresponding additional adjustments being made in the device 10.

The roller assembly 34 includes a roller housing 94, supporting first and second pairs of rotating rollers 90, 92 for engaging the tube to be cut T. The roller housing 94 is engaged in rocking or pivoting relationship with the roller assembly adjustment boss 59 of the cutter wheel housing 38 mounted on a removable roller pin 96. The roller pin 96 engages the adjustment boss 59 of the cutter head assembly housing 25 through the roller housing 94 into either a first opening 60a, as in FIG. 5, for accommodating a first tube diameter T2 between the roller assembly and the cutter wheel assembly, or a second opening 60b, as in FIG. 6, for accommodating a second tube diameter T1, between the roller assembly 34 and the cutter wheel assembly 30. In either position, the roller housing 94 rotates on the roller pin 96 in the directions of the arrow in FIGS. 5 and 6. By simple removal of the roller pin 96 and adjustment of the roller housing 94, an alternative size of tube may be cut.

The door assembly 36 pivots on the cutter head assembly housing 25 between open and closed position. In open position, a door assembly 36 permits a tube to be inserted into the opening 53 for a tube T. In closed position, the door assembly 36 enables the cutter head assembly to surround the tube to be cut T. The door assembly 36 includes a hinge boss 101 for pivoting engagement within a hinge slot 64 in the cutter head assembly housing 25. A hinge screw 69 or other conventional fastener is engaged through hinge pin openings 71b on cover plate 66 and through hinge pin openings 71a on the cutter head assembly housing 25. The door includes a gear face 103 having gear teeth 104, which together with the cutter head assembly gear surface 51, shown in FIG. 7, provides a continuous 360 degree gear surface surrounding the tube T for driving the cutter head assembly 24 by the drive shaft assembly 146. A steel plate 105 is positioned within the door for attracting the magnet 63 located within the cutter head assembly housing 25. A semi-circular tube guide surface 102 is provided spaced from the wall 50 which closes the opening 53 to surround the pipe and provides guiding engagement with the tube T during operation of the tool.

To begin operation of the device 10, an on/off switch 120 is preferably moved to the on position. The on/off switch 120 is schematically shown in FIG. 1 in position captured for operation by a user between tool housing halves 20a, 20b. In the on position, the control system 28 operates the power supply arrangement 12 to power the LED 29 via the wiring harness 27. The LED 29 operates, together with the light pipe 55, to illuminate the work piece or tube and locate the cut position as previously described.

To continue operation, the door assembly 36 may be swung to an open position, shown schematically in FIG. 9b, by detaching the magnet 63 from engagement with the plate 105. Alternatively, the desired tube to be cut T may be easily placed within or slid into the opening 53 and snapped into position cradled within the pairs of first and second rollers 90, 92 using the snap action of the movable roller assembly whether by rocking or pivoting of the roller assembly 34, or by alternative movements such as sliding of the roller assembly. As shown in the embodiment of FIG. 9b, the roller assembly moves by pivoting on pivot pin 96 to permit movement of the tube T to a position engaged with the cutter wheel 32. The moving action of the roller assembly 34 reduces the travel distance to be overcome by the tube T as it moves past the first rollers 90. As shown in the illustration of FIG. 9a, without the advantage of a moveable roller assembly, the tube T must travel past the first roller 90′ a distance of 0.05 inches before reaching the cutting position cradled between the first and second rollers 90′, 92′. The use of a prime designation is used to designate similar structure in a device which is not the present invention.

In the FIG. 9b illustration of the preferred embodiment, the tube T travels only a distance of 0.014 inches before reaching the cutting position between the first and second rollers 90, 92. As a result, the insertion force required to position the tube for cutting is reduced, since the moveable or rocking roller assembly requires less pressure to be applied to the tube T, cutter wheel assembly 30 and rollers 90, 92 during insertion of the tube to be cut. Additionally, the leaf springs 44a, 44b provide a continuous but light force of 50 lbs. or less, and in the preferred embodiment approximately 26 lbs., through the entire cutting operation. Again, the use of a lighter pressure applied to the tube during cutting is believed to provide an improved quality of cut. The trigger switch 124 may then be operated to activate the drive assembly 26 to rotate the cutter head assembly 24.

As shown in FIG. 1, a finger button 122 is used to actuate the trigger run switch 124. The finger button 122 is secured intermediate the tool housing halves 20a, 20b along its surrounding flange 122a and at a hinge 125. The finger button 122 covers a spring 126, which when assembled is seated on a surface 126a of the housing 144 of the drive assembly 26. Once the finger plate 122 is depressed to actuate the trigger run switch 124, the drive assembly 26 is activated to rotate the cutter head assembly 24. It is noted that moving the door assembly 36 to a closed position surrounding the tube may be done manually or automatically. As the cutter head assembly 24 rotates (in the counter clockwise direction shown in FIG. 3), the door 100 is biased into the closed position and magnetic engagement with the cutter head housing assembly 25, upon rotation of the door 100 into the tool housing 20, as shown by the directional arrow in FIG. 3.

Activation of the run switch 124 enables power from the power supply arrangement 12 to operate the motor 18 and drive assembly 26 to rotate the cutter head assembly 24. As shown in FIGS. 1 and 11, the battery 16 portion of the power supply arrangement 12 is positioned within the handle portion 22 of the tool housing 20 and secured therein by a battery door 132. The battery 16 is interconnected at spring contacts 127 with the control system 28, including a printed circuit board 128 having the conventional components depicted in FIG. 11.

Three PC 10 Maxwell Technologies, as shown in FIG. 12, or equivalent ultracapacitors 14 are provided in the present power supply arrangement 12 in parallel with the battery 16. In this arrangement, any initial high power requirements during motor start-up and first rotations of the cutter head assembly 24 which cut the tube T, are sufficiently powered. The present control system 28 and power supply arrangement 12 also use the device on/off switch 120 to charge and discharge the ultracapacitors 14. Again, it is higher revolutions of the cutter head assembly 24, enabled by ensuring a high power supply to the motor 18, especially when combined with the lighter force applied to the tube by the cutter wheel 32 and leaf springs 44a, 44b of the cutter wheel assembly 30, that an improved tube cut is obtained using the present device 10.

A limit switch 130 is provided for sensing position of the cutter head assembly 24 during rotating operation. A moving actuator arm 131 of the switch 130 engages intermittently within groove 61 in the cutter head assembly housing 25 and communicates the position of the actuator arm 131 to the limit switch 130. Once the cut is completed, the user releases finger button 122 to de-actuate the trigger run switch 124. After the sensor arm 131 moves into engagement with the groove 61, as schematically show in FIG. 2, the position of the cutter head assembly 25 is communicated to and determined by the limit switch 130, and control system 28 is signaled to proceed to slow the motor 18 and move the cutter head assembly 24 to a home position where the tube may be removed from the device 10. The LED 29, trigger run switch 124 and limit switch 130 are positioned with the tool housing 20 for mounting engagement with and on pins and other support arms, referenced generally at 144a, and shown in FIG. 1 extending from an outside surface of the housing 144 of the drive assembly 26.

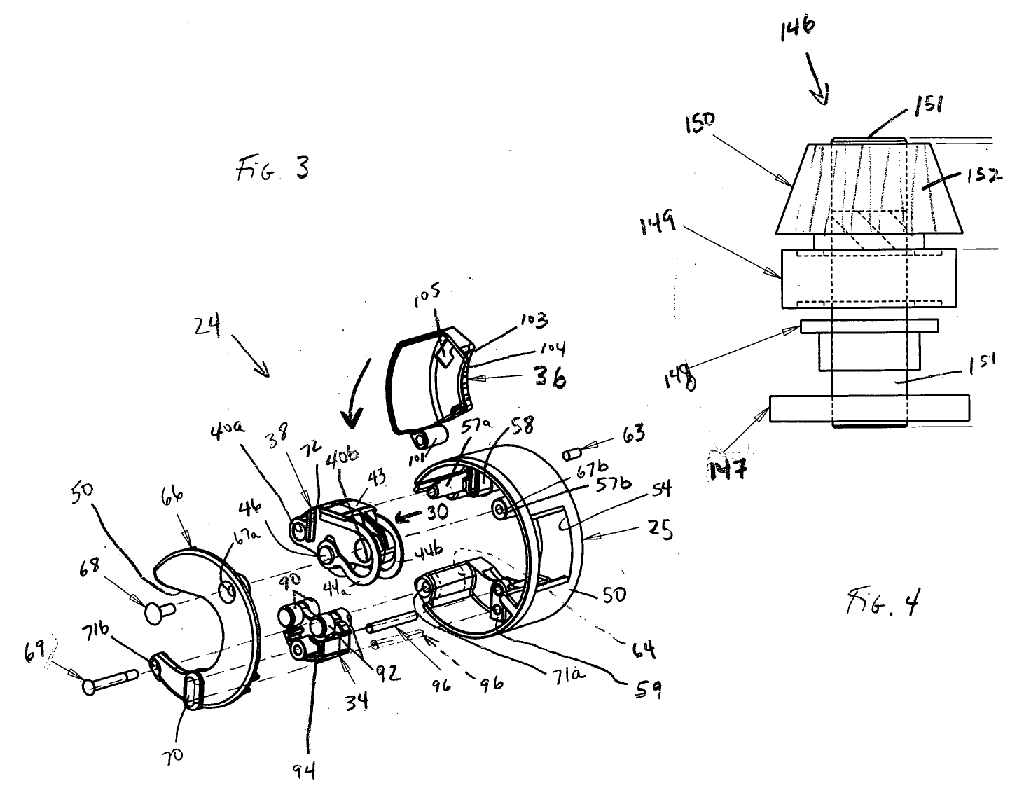

Operation of the drive assembly 26 is initiated upon power being supplied to the motor 18 via biasing of the trigger run switch 124. The motor 18 is interconnected with the control system 28 via the interconnects 140 by Faston company. The motor 18 has a central shaft 141 and motor drive gear 142. The motor drive gear 142 is engaged with reduction cluster gear 143a, 143b to engage the main drive gear 147 of the drive shaft assembly 146 shown in FIGS. 2 and 4. The reduction gear 143a, 143b is manufactured of powdered metal to ensure accuracy and strength, and to reduce operating noise.

The drive assembly 26 and drive shaft assembly 146 are aligned in position and secured within a molded polymer housing 144. As shown in FIG. 2, the housing 144 is centered to surround the motor block, and is secured within the tool housing 20 via conventional fasteners. The reduction gear 143 is aligned within positioned on a shaft 145 also engaged with openings formed in the polymer housing 144.

The drive shaft assembly 146 is supported and aligned on a main drive shaft 151, and further includes a main drive gear 147, a flange bearing 148 which is preferably bronze or another powered metal material, a ball bearing 149 and a nylon pinion gear 150 having gear teeth 152. Operation of the motor 18 using the trigger run switch 124 rotates the motor drive gear and the components of the drive shaft assembly 146 described to rotate the pinion gear 150, the teeth 152 of which are provided in mating engagement with the gear teeth 52 on the cutter wheel assembly 24 for rotating the cutter wheel assembly 24, and engaging the cutter wheel 32 in cutting engagement with the tube T for 360 degrees of rotation. Lubrication may be provided to any or all engaged bearing surfaces for improved operation.

The size and shape of the device 10, including the operating end 21 and angled handle portion 22 of the tool housing 20, are such that full rotation about an existing in-line piece of pipe or on a closed loop piping system is possible in a tight space or difficult to reach location. Once the cut is completed and the cutter wheel assembly 24 is returned to the home position by the control system 28, the device may be readily removed from the tube by simply pulling on the handle portion 22 to open the magnetic latch maintaining the door assembly 36.

Following usage of the device 10, the battery 16, which in the illustrated embodiment is supplied by McNair Technologies Co., Ltd., may be recharged within a conventional battery recharging docking station of the type shown in FIG. 13, with spring battery contacts for mating engagement with battery contacts located on the battery 16. A status light is provided to indicate the charge level status of the battery being charged (a red or green light, for example).

While numerous devices have been described herein in connection with one or more illustrated embodiments, it is understood that present device should not be limited in any way, shape or form to any specific embodiment but rather constructed in broad scope and breadth in accordance with the recitation of the following claims.

We claim:

1. A powered hand held device having
a motor having variable power requirements for performing device operations;
a first source of power using an ultracapacitor for supplying peaks of high power to said motor during device operation; and
a second source of low power continuous operating source to the device in parallel with said first source of power.

2. The powered hand held device of claim 1 wherein said second source of low power is a rechargeable or a disposable battery.

3. The powered hand held device of claim 1 wherein said second source of low power is an AC power supply.

4. The powered hand held device of claim 1 wherein said motor generates rotary motion during performance of device operations.

5. The powered hand held device of claim 1 wherein the device is a tube or pipe cutter tool.

6. The powered hand held device of claim 5 wherein the tube or pipe cutter is a plumbing tool.

7. The powered hand held device of claim 1 wherein the device is a household tool.

8. The powered hand held device of claim 1 wherein the device is a toy or other entertainment device.

9. The powered hand held device of claim 1 wherein the device is a medical device.

10. A tube cutting tool comprising:
a handle portion having a power supply activated by a power switch and a run switch for operation of a tool motor by a user to rotate a cutting head assembly;
said cutting head assembly for rotating engagement surrounding a tube to be cut having,
a spring biased cutter wheel assembly having a cutter wheel for engagement with a tube to be cut;
a movable roller assembly for engagement with a tube to be cut; and
a door assembly for surrounding a tube to be cut during operation of the tool when the door assembly is in a closed position.

11. The tube cutting tool of claim 10 wherein said roller assembly is pivotably or slidably engaged within said cutting head assembly.

12. The tube cutting tool of claim 11 wherein said roller assembly may be moved between a first position for engagement with a first size of tube to be cut and a second position for engagement with a second size of tube to be cut.

13. The tube cutting tool of claim 10 wherein said door assembly is secured in closed position by a magnet.

14. The tube cutting tool of claim 10 wherein said cutter wheel is cryogenically treated to retain its sharpness during use.

15. The tube cutting tool of claim 10 wherein an LED enables marking a cut line on the tube to be cut.

16. The tube cutting tool of claim 15 wherein a light pipe further illuminates the tube to be cut and cut line.

17. The tube cutting tool of claim 10 wherein said power supply comprises a low power source and a high power source in parallel electrical relationship.

18. The tube cutting tool of claim 17 wherein said high power source of said power supply is an ultracapacitor.

19. The tube cutting tool of claim 17 wherein said low power source of said power supply is a rechargeable or a disposable battery.
